(19) United States
(12) Patent Application Publication
(10) Pub. No.: US 2021/0012685 A1
(43) Pub. Date: Jan. 14, 2021

(54) SECURITY LABEL WITH VARIABLE INFORMATION, UPPER LAYER WITH VISUAL BLOCKING, AND TAMPER EVIDENCE AND METHOD OF USE

(71) Applicant: Juan Guillermo VASQUEZ MORENO, Medellin (CO)

(72) Inventor: Juan Guillermo VASQUEZ MORENO, Medellin (CO)

(21) Appl. No.: 16/924,965

(22) Filed: Jul. 9, 2020

(30) Foreign Application Priority Data
Jul. 9, 2019 (CO) NC20190007345

(51) Int. Cl. G09F 3/00

(52) U.S. Cl. CPC G09F 3/0297; G09F 2003/021; G09F 3/0292

(57) ABSTRACT

The present invention is related to a security label with tampering traces that contains variable, random and unrepeatable information, generated by an algorithm that encrypts it, with a top layer visual cover. The present invention corresponds to a product and method, where said label is associated with an App software (from Smartphones or other mobile devices) for reading the variable information from the label of the bottom layer once the top layer is removed and exposes the information to be read in order to determine the origin or legality of the product. Likewise, the label of the present invention allows to make the traceability of the product and allows to determine if the same one has been adulterated, falsified, being robed, or if on the contrary, it is legal and original and can be suitable for its use, consumption and others.

### TECHNICAL FIELD

This invention relates to a security label with an upper layer for visual blockage, which is placed on another tamper evident label that contains variable, random and unrepeatable information, generated by an encrypting algorithm. The label is linked to a software App (for Smart cell phones or other mobile devices) to read the encrypted variable information in the label contained in the lower layer, once the upper layer is removed, and exposes information to be read for determining the origin or legality of the product (QR code, password and consecutive) said information is compared with the information contained in the base software (in the cloud) and its database. Likewise, the label in this present invention enables tracing the product and being able to determine if the product has been adulterated or counterfeited, or, on the contrary, if it is legal and original, and suitable for use, consumption and others.

### INVENTION BACKGROUND

Products counterfeiting and adulteration are currently common practices of unscrupulous people looking to profit from risks that can materialize in people and in companies. Liquors and medicines are among the most frequently counterfeited or adulterated products, and the consumption of a non-original (counterfeited or adulterated) liquor or medicine can lead to serious health problems, including death.

Thus, this counterfeiting and adulteration of products translates into public health and tax problems (taxes that the government does not receive), resulting in a fiscal gap that directly affects a whole country. Thus, the products most prone to counterfeiting or adulteration are liquor, medicines, lubricants, clothing, textiles, purses, footwear, accessories, perfumes, accessories, public documents, etc. where currently there is no way to determine if the product is original or counterfeit, except through evidence of adulteration of a label located on the seal cap or on the physical element. However, counterfeiters have found methods to remove or obtain original labels, and in other cases to reproduce them at very similar levels compared to the originals. These are placed directly on the counterfeit product and are passed as originals, which in turn can lead to a series of previously stated problems, with no control thereof.

In this scenario, there is a plurality of publications in the state of the art related to elements or systems to prevent counterfeiting or to identify a counterfeit or adulterated product. Among them is US 2015014984 document, which refers to a unique identifier with a related high security device which comprises a substrate having a one-dimensional or two-dimensional code, a distribution of 25 flakes, where the flakes are the same or different, and where the distribution of said flakes overlaps, at least partially, with the mentioned code. Thus, the identifier is a self-adhesive marker member comprising a self-adhesive label layer, a modifying resin layer, and a CLCP (chiral liquid crystal polymer) layer, where a code is located in one of the layers to identify the article where the identifying label is located. Said code can be any identification code such as a QR code.

On the other hand, there is document DE 102013011428 which reveals a multi-layer label comprising a support based on a transparent, semi-transparent or matte film. It is provided with a pressure sensitive adhesive. Is has the characteristic of being able to present on its lower side, between the film and the adhesive, an identification code and a text for identifying any type of desired element. Thus, when the upper layer is separated, the text left inside becomes recognizable and can be read by any suitable means.

Furthermore, there is also GB 2527508 document which presents an anti-adulteration or anti-counterfeiting identification label. It is comprised of an opening or window, a transparent adhesive layer, and a plurality of light-absorbing and light-reflecting particles randomly arranged. A unique identification pattern (code) is therefore created, based on the combination of the particles-defined pattern and the characteristics of the surface of the object where the label is used. This pattern is registered in a database which can be accessed to provide object authentication. This way, the particles are preferably two contrasting colors, such as black and white, and form and assist with conventional label graphics and QR codes, such as text, images, etc. The label 25 reveals tampering so it breaks in case of removal attempts.

Likewise, there is US 2016140569 document related to a multi-layer identification label, which

includes an upper layer that with a public identifier, a lower layer with a private identifier, and an adhesive base layer under the lower layer. Then, the upper layer can be attached to the lower layer, and the lower layer may be invisible below the upper layer. This way, peeling or removing the upper layer to reveal the lower layer, leaves evidence of tampering and can demonstrate that the article has been used.

Finally, the state of the art also includes documents CN 101877095 US 2008140432 and GB 2299544. Although they are related to the technical field of the present invention, they can be considered as general disclosures that would not affect compliance with the patentability requirements thereof. Therefore are not included in more detail within this description.

Based on the previous information, it can be clearly seen that the documents found in the state of the art and previously described, correspond to a series of labels or identification devices composed of a plurality of layers. These include an adhesive base layer, an intermediate layer with a printed code or identification, and an upper layer that is removable and indicates product tampering or use where said label is installed or located. Most cases mentioned specifically that the code used is a QR type code which allows product traceability through access to a database.

In accordance with the latter, it is evident to experts that there is need in the state of the art to design and implement a label device or element to be used on the outside of bottles, vessels or containers. An element that enables traceability of the product being purchased, in order to verify that it is original and has not been counterfeited. Said verification must be carried

out in an easy, safe and simple way, preferably through a mobile device, such as smart phones constantly available to users, and connected to the Internet for revision or verification with a suitable database.

This way, the present invention solves the previously mentioned problem more efficiently as it corresponds to a label to do the traceability of the bottle of liquor or medicine, the lubricant container, footwear, etc. The user, with it, can look up for certification and traceability of said product, and determine if the product to be consumed is original, adulterated, counterfeit or stolen, or if it has restrictions on retail prices, or if it has been destined to be sold in a different region. Furthermore, the label can be easily read by means of a smartphone with the application developed for this purpose, and by means of a simple Internet connection checks the product's status and originality in a database.

### BRIEF DESCRIPTION OF THE FIGURES

The present invention can be better understood based on the following figures which show all the parts and components, as well as the new features differing from the state of the art. The figures illustrate the invention in a preferred modality but they are not intended to limit the scope thereof, which is provided only by the enclosed claims. Thus, in the figures attached to the present description we have:

FIG. 1 corresponds to a general view of the security and tampering/adulteration/counterfeiting evident label of the present invention.

FIG. 2 corresponds to a general view of the label of FIG. 1, after being detached and showing the code inside it.

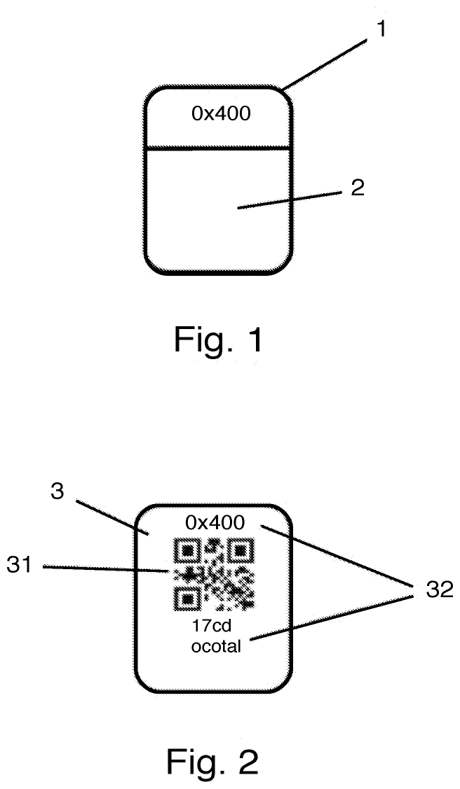

### DETAILED DESCRIPTION OF THE INVENTION

This invention corresponds to a label to reveal product tampering, and a method to certify product originality and do traceability thereof, characterized for including:
A label with tampering traces (void) that contains variable, random and unrepeatable information, generated by an encrypting algorithm. Said information refers to a product and is visually protected from consumers through a tampering evident adhesive upper layer. The information is exposed when the upper layer of said label is removed; and
A part containing variable, random and unrepeatable information in the form of a code or pattern and numbers or letters, covered by the adhesive upper layer. Once the label's hidden information is accessed, it is read by a mobile device application that consults the encrypted information and the validation software responds to the code reading. The labels are attached to the product that needs to be certified or origin validated (to avoid counterfeit liquor, oils, medicines, clothing, etc.).

The method to demonstrate product tampering and originality traceability related to the label, includes the following steps:

To generate, through the use of a computational element, variable, random and unrepeatable information in the form of a code or pattern related to a product; capture said information on a label; cover said information with an upper layer; remove said upper layer; read or scan the code or pattern with a mobile device as a smartphone; validate the code information with the database; provide information about the associated product; cancel the code for the first reading.

When the information is read, the system determines if the code read is original (first time it is read) and sends complete information of the product related (product image, manufacturer or producer, serial, batch, originality, consumption area, maximum price for retail, etc.) The automatically-read code is disabled in the database and becomes non-functional, in such a way that if someone re-scans it or the information from the label is copied and pasted to a product, the label and the information contained in it is no longer valid. This means that the product is a NOT-original, illegal, counterfeit, adulterated or stolen, depending on the circumstance and cycle status.

In accordance with the latter, the most important and relevant characteristics of the present invention, those making it different from similar devices that exist in the state of the art, correspond, first of all, to the fact that a method is available by means of a double-layer protected and tamper evident (void) label, linked to a software application to certify product origin. The system, through the label information associated with the App, also enables: 1. Origin verification. 2. Cancellation of code through the first reading. 3. Product traceability. 4. Geo-reference of consumption (Geographical location) which enables heat maps for consumption, falsification, illegality and theft. 5. Loyalty programs based on consumption, with accumulation of points related to the product and the label. 6. Redemption of points including allies ‘product exchanges.

Additionally, there is online origin certification with technologically complex labels, of low cost elaboration (Technology based on label-software). It allows making labels in conventional machines and papers of all kinds. Its fundamental characteristic is the union of layers with tamper evidence when being removed, the external layer is not reusable and the information is not visible until it is opened.

1. A tamper evident and product originality traceability label, characterized for comprising:
A label (1);
An upper layer over said tamper evident adhesive label (2);
A part containing variable, random and unrepeatable (3) information in the form of a code or pattern (31) and numbers or letters (32), covered by an adhesive upper layer.

2. The label, according to claim 1, characterized because the code used in the label is of QR type associated to an alphanumeric code and a consecutive number.

3. The method to demonstrate product tampering and originality traceability, characterized because includes the following stages: to generate, through the use of a computational element, variable, random and unrepeatable information in the form of a code or pattern related to a product; capture said information on a label; cover said information with an upper layer; remove said upper layer; read or scan the code or pattern with a mobile device as a smartphone; validate the code information with the database; provide information about the associated product; cancel the code due to a first reading.

4. The method of claim 3 characterized because the information that it provides about the product corresponds to the image that identifies the product, its manufacturer or producer, serial, batch, originality, consumption area, maximum retail price, number of times the product has been scanned.

5. The method of claim 3 characterized because the code used in the label is of QR type associated to an alphanumeric code and a consecutive number.
